(19) United States
(12) Patent Application Publication
(10) Pub. No.: US 2025/0076476 A1
(43) Pub. Date: Mar. 6, 2025

(54) SIMULATING INTENSITY FROM RANGE DATA

(71) Applicant: GM Cruise Holdings LLC, San Francisco, CA (US)

(72) Inventors: Luyu Yang, Seattle, WA (US); Surya Dwarakanath, San Francisco, CA (US); Ashish Shrivastava, San Jose, CA (US)

(21) Appl. No.: 18/459,088

(22) Filed: Aug. 31, 2023

(51) Int. Cl. G01S 7/497

(52) U.S. Cl. CPC G01S 7/497

(57) ABSTRACT

Systems and methods of simulating a LiDAR return signal are disclosed. The method includes the creation of a model of an object and a LiDAR unit in a virtual environment. The LiDAR return signal includes the return intensity of a reflection of an incident illumination beam by the object. The model determines the LiDAR return signal based in part on a range from the LiDAR unit to the object and an object label. The model is trained with a set of road data records each having a measured range, a measured return intensity, and an object label. The trained model simulates a LiDAR illumination beam emitted by the LiDAR unit toward the object and determines the return intensity of the reflection of an incident portion of the emitted illumination beam.

### BACKGROUND

### 1. Technical Field

The present disclosure generally relates to the construction of simulated Light Detection And Ranging (LiDAR) data for use in training control systems for use in an autonomous vehicle (AV).

### 2. Introduction

As AV technologies continue to advance, they will be increasingly used to improve transportation efficiency and safety. As such, AVs will need to perform many of the functions conventionally performed by human drivers, such as performing navigation and routing tasks necessary to provide a safe and efficient transportation. Such tasks may require the collection and processing of data describing the surrounding environment using various sensor types, including LiDAR sensors disposed on the AV.

Development of the navigation system includes training portions of the system using simulated Light Detection and Ranging (LiDAR) data. While a simulation provides certain information not available in real-world LiDAR measurements, other data cannot be easily predicted from first principles via simulation.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings.

FIG. 1 illustrates an example AV environment, according to some aspects of the disclosed technology.

FIG. 2 illustrates example objects in an AV environment, according to certain aspects of the disclosed technology.

FIG. 3 illustrates an example system environment that can be used to facilitate AV operations, according to some aspects of the disclosed technology.

FIG. 4 is a diagram illustrating an example simulation framework, according to some aspects of the disclosed technology.

FIG. 5 illustrates the effect of object characteristics on the reflection of a LiDAR illumination beam, according to some aspects of the disclosed technology.

FIG. 6 illustrates diffuse and specular reflection, according to some aspects of the disclosed technology.

### DETAILED DESCRIPTION

The detailed description set forth herein is intended as a description of various example configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. It will be clear and apparent that the subject technology is not limited to the specific details set forth herein and may be practiced without these details. In some instances, structures and components are shown in block diagram form in order to avoid obscuring the concepts of the subject technology.

AV navigation systems require information about the surrounding environment in order to avoid objects/entities as well as navigate through the environment. The AV perceives objects around itself through multiple types of sensors, e.g., imaging cameras and Light Detection and Ranging (LiDAR) sensors. When an object is detected, it is classified and assigned a label that is associated with various characteristics of the object. a real-world LiDAR signal comprises a range and an intensity. Training of a navigation system if often done within a simulated environment and requires extensive input data, e.g., the LiDAR sensor output. It is desirable to simulate the LiDAR sensor output. While the simulation includes a model of an object being sensed by a LiDAR sensor, the intensity of the reflected LiDAR beam is not easily calculated based solely on the characteristics of the object.

The systems and methods disclosed herein address this issue with conventional simulations by teaching a neural network to provide an intensity of the reflected LiDAR beam based on the range of the object from the LiDAR sensor as well as known characteristics of the object.

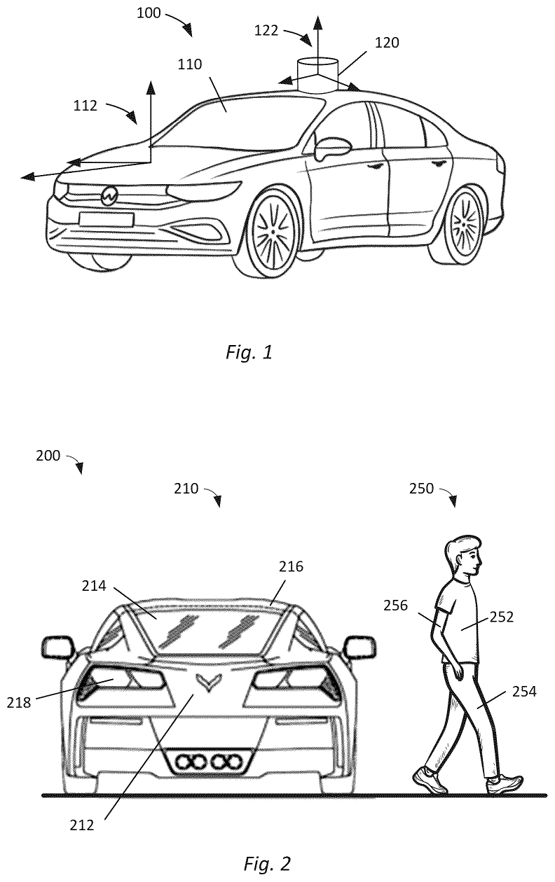

FIG. 1 illustrates an example AV environment 100, according to certain aspects of the disclosed technology. A LiDAR system 120 is disposed on a vehicle 110, e.g., an AV, and configured to scan a field of view (FOV). In certain aspects, the LiDAR system 110 has a sparse illumination and/or detector configuration. In certain aspects, the LiDAR illumination is a near-field flash system. In certain aspects, the LiDAR sensor 120 scans its environment by rotating an emitter/receiver subassembly (not visible in FIG. 1) about a vertical axis and has a coordinate system 122 that rotates with the emitter/receiver subassembly. The vehicle 110 has its own coordinate system 112 fixed with respect to the body of the vehicle 110.

The LiDAR sensor 120 “perceives” an object that is within the FOV by emitting an illumination beam at a known azimuth direction and a known vertical angle. The receiver of the LiDAR sensor 120 detects a reflection of the illumination beam by the object and measures the range of the object from the LiDAR sensor 120 and an intensity of the reflected beam. In certain aspects, there are multiple emitter/receiver pairs arranged at different vertical angles so that a vertical swath of the environment is scanned simultaneously. As the emitter/receiver subassembly rotates, vertical swaths are scanned incrementally, thereby providing a 360-degree view of the environment. From the multiple reflects received within a swath and from adjacent swaths, a complete picture of an object is created, which enables classification of the sensed object and assignment of a label.

FIG. 2 illustrates example objects in an AV environment 200, according to certain aspects of the disclosed technology. One example object is a vehicle 210 and a second example object is a person 250 such as might be encountered at an intersection or traffic light.

The vehicle 210 has multiple surfaces that are scanned by a LiDAR sensor. For example, the rear body panel 212, the rear window 214, the roof 216, and the taillight 218. Each surface has characteristics that include an associated material, a surface finish, a color, a distance from the LiDAR sensor, and an orientation relative to the LiDAR sensor. In this example, the rear panel 212 is a glossy red painted surface that is nearly perpendicular to the illumination beam coming from the LiDAR sensor while the rear window 214 is tinted glass at a large angle to the illumination beam. Each surface will reflect the incident illumination beam in a different way based on the characteristics of that surface. As the illumination beam has a frequency, each surface will also have an absorbance for that frequency based on its characteristics.

The person 250 also has multiple surfaces. In this example, the person 250 is wearing a white cotton T-shirt 252 and a dark blue cotton pair of jeans 254. Portions of the person's body, e.g., his arm 256, are exposed.

A real-world LiDAR sensor returns a limited amount of information, as shown in Table 1 for the example environment of FIG. 2. Example ranges are provide in centimeters while intensities of the portion of the reflection of the illumination beam that is received by the LiDAR sensor is provided on a normalized scale (0-100). In general, the real-world LiDAR sensor does not obtain any information on the characteristics of the sensed object.

TABLE 1

| | RANGE | INTENSITY |
|---|---|---|
| FEATURE# | (cm) | (0-100) |
| 212 | 342 | 71 |
| 214 | 367 | 34 |
| 216 | 385 | 22 |
| 218 | 345 | 0 |
| 252 | 350 | 36 |
| 254 | 352 | 24 |
| 256 | 346 | 29 |

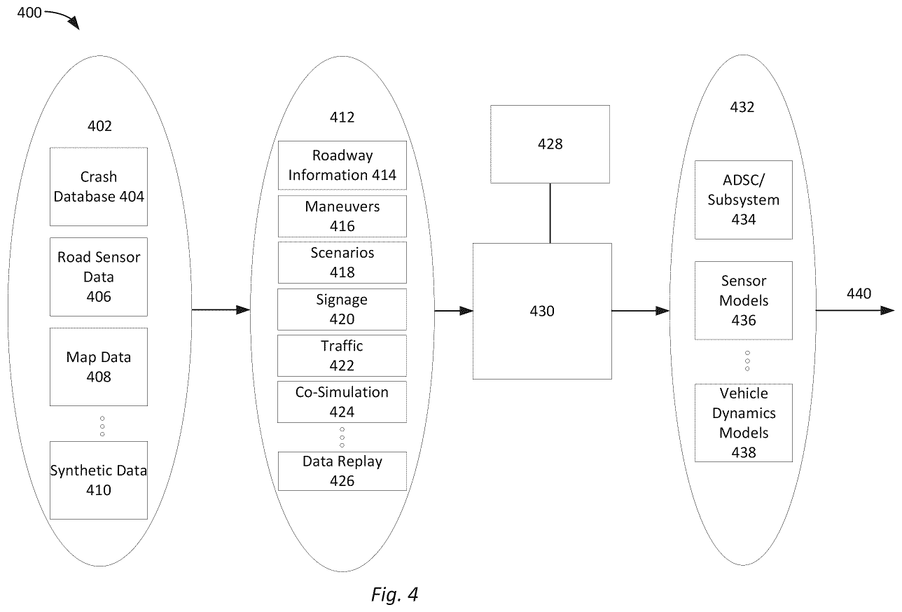

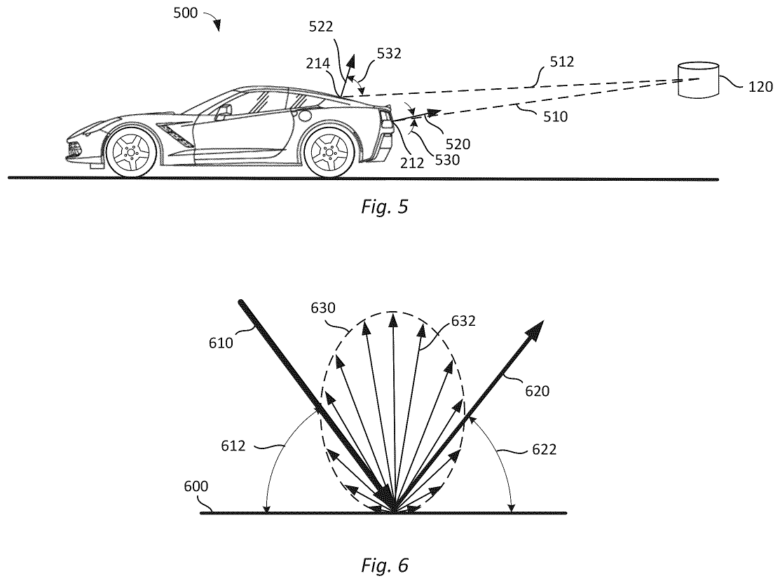

A simulation has a great deal of information about modeled objects. In certain aspects, this information includes the size, location, and orientation of the surfaces of the object as well as the material and/or material properties of each surface, the reflectance of each surface, and the reflective characteristics of each surface. The effect of certain characteristics on the reflected illumination beam is discussed with respect to FIGS. 4-5. In this example, Table 2 lists the characteristics of each surface, which include a normalized reflectance (0-100) a normalized diffuse-specular parameter (1-10) as well as the time-varying range and orientation of the surface from the LiDAR unit (also: LiDAR sensor).

TABLE 2

| | REFLEC- | DIFFUSE- | | ORIENTATION |
|---|---|---|---|---|
| | TANCE | SPECULAR | RANGE | (degrees from |
| MATERIAL | 1-100 | (1-10) | (cm) | perpendicular) |
| gloss paint | 43 | 6-9 | 342 | 2 |
| glass | 16 | 3-7 | 367 | 45 |
| gloss paint | 43 | 6-9 | 385 | 80 |
| plastic | 22 | 3-7 | 345 | 5 |
| polyester | 17 | 2-5 | 350 | 9 |
| cotton | 12 | 2-4 | 352 | 6 |
| skin | 21 | 2-6 | 346 | 20 |

reflectance—amount of energy reflected vs absorbed
diffuse-specular: paint—polish, dirt; plastic—finish/texture, transparency; fabric—weave, coarseness

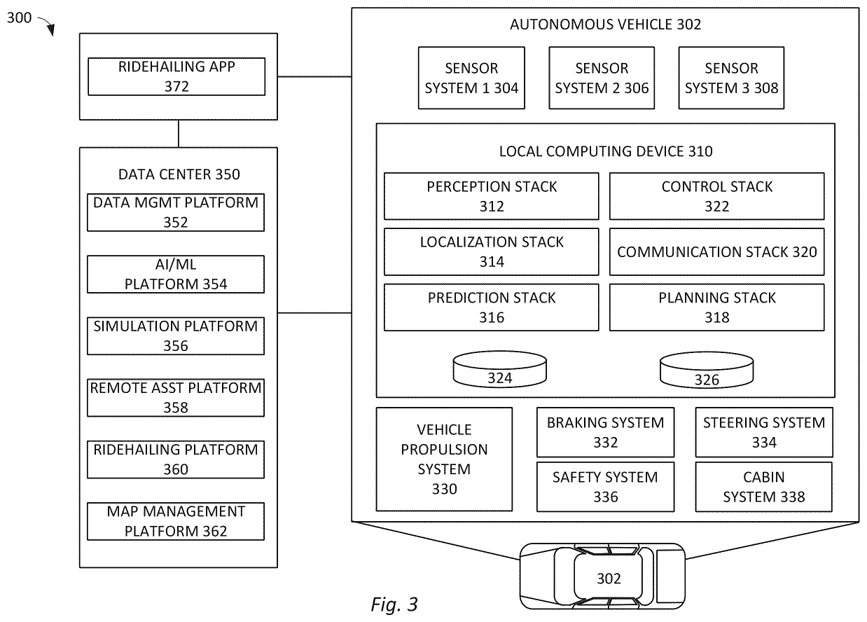

FIG. 3 illustrates an example system environment that can be used to facilitate AV operations, according to some aspects of the disclosed technology. One of ordinary skill in the art will understand that, for AV environment 300 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill in the art will appreciate that such variations do not depart from the scope of the present disclosure.

In this example, the AV environment 300 includes an AV 302, a data center 350, and a client computing device 370. The AV 302, the data center 350, and the client computing device 370 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 302 can navigate roadways without a human driver based on sensor signals generated by multiple sensor systems 304, 306, and 308. The sensor systems 304-308 can include one or more types of sensors and can be arranged about the AV 302. For instance, the sensor systems 304-308 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 304 can be a camera system, the sensor system 306 can be a LIDAR system, and the sensor system 308 can be a RADAR system. Other examples may include any other number and type of sensors.

The AV 302 can also include several mechanical systems that can be used to maneuver or operate the AV 302. For instance, mechanical systems can include a vehicle propulsion system 330, a braking system 332, a steering system 334, a safety system 336, and a cabin system 338, among other systems. The vehicle propulsion system 330 can include an electric motor, an internal combustion engine, or both. The braking system 332 can include an engine brake, brake pads, actuators, and/or any other suitable componentry configured to assist in decelerating the AV 302. The steering system 334 can include suitable componentry configured to control the direction of movement of the AV 302 during navigation. The safety system 336 can include lights and signal indicators, a parking brake, airbags, and so forth. The cabin system 338 can include cabin temperature control systems, in-cabin entertainment systems, and so forth. In some examples, the AV 302 might not include human driver actuators (e.g., steering wheel, handbrake, foot brake pedal, foot accelerator pedal, turn signal lever, window wipers, etc.) for controlling the AV 302. Instead, the cabin system 338 can include one or more client interfaces (e.g., Graphical User Interfaces (GUIs), Voice User Interfaces (VUIs), etc.) for controlling certain aspects of the mechanical systems 330-338.

The AV 302 can include a local computing device 310 that is in communication with the sensor systems 304-308, the mechanical systems 330-338, the data center 350, and the client computing device 370, among other systems. The local computing device 310 can include one or more processors and memory, including instructions that can be executed by the one or more processors. The instructions can make up one or more software stacks or components responsible for controlling the AV 302; communicating with the data center 350, the client computing device 370, and other systems; receiving inputs from riders, passengers, and other entities within the AV's environment; logging metrics collected by the sensor systems 304-308; and so forth. In this example, the local computing device 310 includes a perception stack 312, a localization stack 314, a prediction stack 316, a planning stack 318, a communications stack 320, a control stack 322, an AV operational database 324, and an HD geospatial database 326, among other stacks and systems.

Perception stack 312 can enable the AV 302 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 304-308, the localization stack 314, the HD geospatial database 326, other components of the AV, and other data sources (e.g., the data center 350, the client computing device 370, third party data sources, etc.). The perception stack 312 can detect and classify objects and determine their current locations, speeds, directions, and the like. In addition, the perception stack 312 can determine the free space around the AV 302 (e.g., to maintain a safe distance from other objects, change lanes, park the AV, etc.). The perception stack 312 can identify environmental uncertainties, such as where to look for moving objects, flag areas that may be obscured or blocked from view, and so forth. In certain aspects, an output of the perception stack 312 can be a bounding area around a perceived object, referred to herein as a “footprint,” that can be associated with a semantic label that identifies the type of object that is within the bounding area, the size of the object, the kinematic of the object (information about its movement), a tracked path of the object, and a description of the pose of the object (its orientation or heading, etc.). In certain aspects, the perception stack associates the object with a predetermined class of objects.

Localization stack 314 can determine the AV's position and orientation (pose) using different methods from multiple systems (e.g., GPS, IMUs, cameras, LIDAR, RADAR, ultrasonic sensors, the HD geospatial database 326, etc.). For example, in some cases, the AV 302 can compare sensor data captured in real-time by the sensor systems 304-308 to data in the HD geospatial database 326 to determine its precise (e.g., accurate to the order of a few centimeters or less) position and orientation. The AV 302 can focus its search based on sensor data from one or more first sensor systems (e.g., GPS) by matching sensor data from one or more second sensor systems (e.g., LIDAR). If the mapping and localization information from one system is unavailable, the AV 302 can use mapping and localization information from a redundant system and/or from remote data sources.

Prediction stack 316 can receive information from the localization stack 314 and objects identified by the perception stack 312 and predict a future path for the objects. In some examples, the prediction stack 316 can output several likely paths that an object is predicted to take along with a probability associated with each path. For each predicted path, the prediction stack 316 can also output a range of points along the path corresponding to a predicted location of the object along the path at future time intervals along with an expected error value for each of the points that indicates a probabilistic deviation from that point.

Planning stack 318 can determine how to maneuver or operate the AV 302 safely and efficiently in its environment. For example, the planning stack 318 can receive the location, speed, and direction of the AV 302, geospatial data, data regarding objects sharing the road with the AV 302 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 302 from one point to another and outputs from the perception stack 312, localization stack 314, and prediction stack 316. The planning stack 318 can determine multiple sets of one or more mechanical operations that the AV 302 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 318 can select from multiple backup plans to carry out. For example, while preparing to change lanes to turn right at an intersection, another vehicle may aggressively cut into the destination lane, making the lane change unsafe. The planning stack 318 could have already determined an alternative plan for such an event. Upon its occurrence, it could help direct the AV 302 to go around the block instead of blocking a current lane while waiting for an opening to change lanes.

Control stack 322 can manage the operation of the vehicle propulsion system 330, the braking system 332, the steering system 334, the safety system 336, and the cabin system 338. The control stack 322 can receive sensor signals from the sensor systems 304-308 as well as communicate with other stacks or components of the local computing device 310 or a remote system (e.g., the data center 350) to effectuate operation of the AV 302. For example, the control stack 322 can implement the final path or actions from the multiple paths or actions provided by the planning stack 318. This can involve turning the routes and decisions from the planning stack 318 into commands for the actuators that control the AV's steering, throttle, brake, and drive unit.

In certain aspects, the control stack 322, receives input from the Remote Advisor, e.g., through the remote assistance platform 358, that are an additional input to the algorithms of the control stack 322. In certain aspects, the control stack 322 weighs the input from the Remote Advisor. For example, a respective weighting factor is assigned to each input based on characteristics of the scene, e.g., an estimated visibility of the object due to environmental factors such as lighting. As another example, different weighting factors are assigned based on the particular Remote Advisor, e.g., years of experience in the role of Remote Advisor and/or job performance. In certain aspects, different sets of weighting factors are associated with different conditions. For example, a first set of weighting factors is used when the Remote Advisor is receiving low-quality information, e.g., low resolution video, significant latency in the video feed, or a low contrast image (due to a light failure on the AV), while a second set of weighting factors is used when the Remote Advisor is receiving high-quality data, e.g., high resolution images, low latency, or an image with good contrast. In certain aspects, this weighting functionality is implemented in another stack of the local computing device 310, e.g., the perception stack 312. In certain aspects, this weighting functionality is implemented in the remote assistance platform 358.

Communications stack 320 can transmit and receive signals between the various stacks and other components of the AV 302 and between the AV 302, the data center 350, the client computing device 370, and other remote systems. The communications stack 320 can enable the local computing device 310 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 320 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 326 can store HD maps and related data of the streets upon which the AV 302 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

AV operational database 324 can store raw AV data generated by the sensor systems 304-308, stacks 312-322, and other components of the AV 302 and/or data received by the AV 302 from remote systems (e.g., the data center 350, the client computing device 370, etc.). In some examples, the raw AV data can include HD LIDAR point cloud data, image data, RADAR data, GPS data, and other sensor data that the data center 350 can use for creating or updating AV geospatial data or for creating simulations of situations encountered by AV 302 for future testing or training of various machine learning algorithms that are incorporated in the local computing device 310.

Data center 350 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 350 can include one or more computing devices remote to the local computing device 310 for managing a fleet of AVs and AV-related services. For example, in addition to managing the AV 302, the data center 350 may also support a ride-hailing service (e.g., a ridesharing service), a delivery service, a remote/roadside assistance service, street services (e.g., street mapping, street patrol, street cleaning, street metering, parking reservation, etc.), and the like.

Data center 350 can send and receive various signals to and from the AV 302 and the client computing device 370. These signals can include sensor data captured by the sensor systems 304-308, roadside assistance requests, software updates, ride-hailing/ridesharing pick-up and drop-off instructions, and so forth. In this example, the data center 350 includes a data management platform 352, an Artificial Intelligence/Machine Learning (AI/ML) platform 354, a simulation platform 356, a remote assistance platform 358, and a ride-hailing platform 360, and a map management platform 362, among other systems.

Data management platform 352 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of data center 350 can access data stored by the data management platform 352 to provide their respective services.

The AI/ML platform 354 can provide the infrastructure for training and evaluating machine learning algorithms for operating the AV 302, the simulation platform 356, the remote assistance platform 358, the ride-hailing platform 360, the map management platform 362, and other platforms and systems. Using the AI/ML platform 354, data scientists can prepare data sets from the data management platform 352; select, design, and train machine learning models; evaluate, refine, and deploy the models; maintain, monitor, and retrain the models; and so on.

Simulation platform 356 can enable testing and validation of the algorithms, machine learning models, neural networks, and other development efforts for the AV 302, the remote assistance platform 358, the ride-hailing platform 360, the map management platform 362, and other platforms and systems. Simulation platform 356 can replicate a variety of driving environments and/or reproduce real-world scenarios from data captured by the AV 302, including rendering geospatial information and road infrastructure (e.g., streets, lanes, crosswalks, traffic lights, stop signs, etc.) obtained from a cartography platform (e.g., map management platform 362); modeling the behavior of other vehicles, bicycles, pedestrians, and other dynamic elements; simulating inclement weather conditions, different traffic scenarios; and so on.

Remote assistance platform 358 can generate and transmit instructions regarding the operation of the AV 302. For example, in response to an output of the AI/ML platform 354 or other system of the data center 350, the remote assistance platform 358 can prepare instructions for one or more stacks or other components of the AV 302.

Ride-hailing platform 360 can interact with a customer of a ride-hailing service via a ride-hailing application 372 executing on the client computing device 370. The client computing device 370 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 372. The client computing device 370 can be a customer's mobile computing device or a computing device integrated with the AV 302 (e.g., the local computing device 310). The ride-hailing platform 360 can receive requests to pick up or drop off from the ride-hailing application 372 and dispatch the AV 302 for the trip.

Map management platform 362 can provide a set of tools for the manipulation and management of geographic and spatial (geospatial) and related attribute data. The data management platform 352 can receive LIDAR point cloud data, image data (e.g., still image, video, etc.), RADAR data, GPS data, and other sensor data (e.g., raw data) from one or more AVs 302, Unmanned Aerial Vehicles (UAVs), satellites, third-party mapping services, and other sources of geospatially referenced data. The raw data can be processed, and map management platform 362 can render base representations (e.g., tiles (2D), bounding volumes (3D), etc.) of the AV geospatial data to enable users to view, query, label, edit, and otherwise interact with the data. Map management platform 362 can manage workflows and tasks for operating on the AV geospatial data. Map management platform 362 can control access to the AV geospatial data, including granting or limiting access to the AV geospatial data based on user-based, role-based, group-based, task-based, and other attribute-based access control mechanisms. Map management platform 362 can provide version control for the AV geospatial data, such as to track specific changes that (human or machine) map editors have made to the data and to revert changes when necessary. Map management platform 362 can administer release management of the AV geospatial data, including distributing suitable iterations of the data to different users, computing devices, AVs, and other consumers of HD maps. Map management platform 362 can provide analytics regarding the AV geospatial data and related data, such as to generate insights relating to the throughput and quality of mapping tasks.

In some aspects, the map viewing services of map management platform 362 can be modularized and deployed as part of one or more of the platforms and systems of the data center 350. For example, the AI/ML platform 354 may incorporate the map viewing services for visualizing the effectiveness of various object detection or object classification models, the simulation platform 356 may incorporate the map viewing services for recreating and visualizing certain driving scenarios, the remote assistance platform 358 may incorporate the map viewing services for replaying traffic incidents to facilitate and coordinate aid, the ride-hailing platform 360 may incorporate the map viewing services into the client application 372 to enable passengers to view the AV 302 in transit enroute to a pick-up or drop-off location, and so on.

While the autonomous vehicle 302, the local computing device 310, and the autonomous vehicle environment 300 are shown to include certain systems and components, one of ordinary skill will appreciate that the autonomous vehicle 302, the local computing device 310, and/or the autonomous vehicle environment 300 can include more or fewer systems and/or components than those shown in FIG. 3. For example, the autonomous vehicle 302 can include other services than those shown in FIG. 3 and the local computing device 310 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 3.

In certain aspects, the remote assistance platform 358 comprises a user interface (not shown in FIG. 3) that enables a human Remote Advisor to view the environment around the AV through one or more of the sensor systems 304, 306, 308 and issue commands to the local computing device 310 of the AV 302. In certain aspects, the remote assistance platform 358 notifies a human Remote Advisor that an “event” has occurred wherein the AV 302 requires assistance to resolve the event. In certain aspects, the event comprises a situation wherein the AV 302 is unable to navigate past an object that obstructs its planned path. In certain aspects, the event comprises a situation wherein the AV 302 predicts that it will be unable to navigate past an object at some point along its planned path, although the AV is continuing on the path at the time of notification. In certain aspects, the remote assistance platform 358 comprises a set of rules that describe at least one of allowed actions and prohibited actions. In certain aspects, the remote assistance platform 358 provides information from a time period leading up to the event that has stopped the AV 302. In certain aspects, the remote assistance platform 358 provides a recommendation, e.g., a determination about how to modify an object's footprint, based not only on what is currently being perceived by the sensor systems 304, 306, 308 but also on what has been recently perceived by the sensor systems 304, 306, 308. In certain aspects, the remote assistance platform 358 comprises limits on how a change in perception is implemented, e.g., a perception change can only be implemented while holding the AV 302 stationary. In certain aspects, a change in perception is allowed to be implemented while the AV 302 in motion under certain conditions.

With reference to certain aspects of the systems and methods disclosed herein, the data center 350 comprises a site controller (not shown) that manages the parking of AVs in a parking area, e.g., a parking lot, a service area, or a support site for the maintenance, servicing, and storage of AVs. In certain aspects, the site controller is provided as a software service running on a processor, e.g., a central server with associated memory storage, co-located with other functions of the data center 350. In certain aspects, the site controller is provided as a standalone hardware system that comprises a processor and a memory and is located at a separate location, e.g., a parking area managed by the site controller. In either embodiment, the memory comprises one or more of instructions that, when loaded into the processor and executed, cause the processor to execute the methods of managing the site as disclosed herein.

FIG. 4 is a diagram illustrating an example simulation framework 400, according to some examples of the present disclosure. The example simulation framework 400 includes data sources 402, content 412, environmental conditions 428, parameterization 430, and a simulator 432. The components in the example simulation framework 400 are merely illustrative examples provided for explanation purposes. In certain aspects, the simulation framework 400 includes other components that are not shown in FIG. 4 and/or more or less components than shown in FIG. 4.

In certain aspects, the data sources 402 are used to create a simulation. In certain aspects, the data sources 402 include one or more of a crash database 404, road sensor data 406, map data 408, and/or synthetic data 410. In certain aspects, the data sources 402 include more or less sources than shown in FIG. 4 and/or one or more data sources that are not shown in FIG. 4.

In certain aspects, the crash databases 404 includes crash data, e.g., data describing crashes and/or associated details, generated by vehicles involved in crashes. In certain aspects, the road sensor data 406 includes data collected by one or more sensors, e.g., camera sensors, LiDAR sensors, RADAR sensors, SONAR sensors, IMU sensors, GPS/GNSS receivers, and/or any other sensors, of one or more vehicles while the one or more vehicles drive/navigate one or more real-world environments. In certain aspects, the map data 408 includes one or more maps and, in some cases, associated data, e.g., a high-definition (HD) map, a sensor map, a scene map, and/or any other map. In some aspects, the HD map includes roadway information, e.g., a lane width, a location of a road sign and/or a traffic light, a direction of travel for a lane, road junction information, and speed limit information.

In certain aspects, the synthetic data 410 includes one or more of a virtual asset, an object, and/or an element created for a simulated scene, a virtual scene, a virtual scene element, and any other synthetic data element. In certain aspects, the synthetic data 410 includes one or more of a virtual vehicle, a virtual pedestrian, a virtual road, a virtual object, a virtual environment/scene, a virtual sign, a virtual background, a virtual building, a virtual tree, motorcycle, a virtual bicycle, a virtual obstacle, a virtual environmental element, e.g., weather and/or lightning, a shadow, and/or a virtual surface. In certain aspects, the synthetic data 410 includes synthetic sensor data such as synthetic camera data, synthetic LiDAR data, synthetic RADAR data, synthetic IMU data, and/or any other type of synthetic sensor data.

In certain aspects, data from one or more of the data sources 402 is be used to create the content 412. In certain aspects, the content 412 includes static content and/or dynamic content. In certain aspects, the content 412 includes roadway information 414, a maneuver 416, a scenario 418, signage 420, traffic 422, a co-simulation 424, and/or data replay 426. In certain aspects, the roadway information 414 includes one or more of lane information, e.g., number of lanes and/or lane widths and/or directions of travel for each lane, the location and information of a road sign and/or a traffic light, road junction information, speed limit information, a road attribute, e.g., surfaces and/or angles of inclination and/or curvatures and/or obstacles, road topologies, and/or other roadway information. In certain aspects, the maneuver 416 includes any AV maneuver and the scenario 418 includes a specific AV behavior in a certain AV scenes/environment. The signage 420 includes one or more signs, e.g., a traffic light, a road sign, a billboard, and a message displayed on the road. In certain aspects, the traffic 422 includes traffic information such as traffic density, traffic fluctuations, traffic patterns, traffic activity, delays, positions of traffic, velocities, volumes of vehicles in traffic, geometries or footprints of vehicles, pedestrians, and occupied and/or unoccupied spaces.

In certain aspects, the co-simulation 424 includes a distributed modeling and simulation of different AV subsystems that form the larger AV system. In certain aspects, the co-simulation 424 includes information for connecting separate simulations together with interactive communications. In certain aspects, the co-simulation 424 allows for modeling to be done at a subsystem level while providing interfaces to connect the subsystems to the rest of the system, e.g., the autonomous driving system computer. In certain aspects, the data replay 426 includes replay content produced from real-world sensor data, e.g., road sensor data 406.

The environmental conditions 428 include information about environmental conditions 428, e.g., atmospheric conditions. In certain aspects, the environmental conditions comprise one or more of road/terrain conditions such as surface slope or gradient, surface geometry, surface coefficient of friction, road obstacles, illumination, weather, road and/or scene conditions resulting from one or more environmental conditions.

Content 412 and environmental conditions 428 can be used to create the parameterization 430. In certain aspects, the parameterization 430 includes parameter ranges, parameterized scenarios, probability density functions of one or more parameters, sampled parameter values, parameter spaces to be tested, evaluation windows for evaluating a behavior of an AV in a simulation, scene parameters, content parameters, and environmental parameters. Parameterization 430 can be used by simulator 432 to generate simulation 440.

In certain aspects, the simulator 432 includes a software engine, an algorithm, a neural network model, and/or a software component used to generate simulations, such as simulation 440. In certain aspects, the simulator 432 includes one or more of an autonomous driving system computer (ADSC)/subsystem model 434, a sensor model 436, and a vehicle dynamics model 438. In certain aspects, the ADSC/subsystem model 434 includes a model, a descriptor, and/or an interface for one or more of the ADSC and/or the ADSC subsystems, e.g., a perception stack 112, a localization stack 114, a prediction stack 116, a planning stack 118, a communications stack 120, a control stack 122, a sensor system, and/or any other subsystems.

In certain aspects, the sensor model 436 includes a mathematical representation of a hardware sensor and an operation, e.g., sensor data processing, of one or more sensors, e.g., a LiDAR, a RADAR, a SONAR, a camera sensor, an IMU, and/or any other sensor. In certain aspects, sensor model 436 includes a LiDAR sensor model that simulates operation of a LiDAR sensor, e.g., a LiDAR sensor model used to simulate transmission of LiDAR beams in the simulation 440 and simulate LiDAR measurements such as range, and/or intensity corresponding to one or more objects in the simulation 440. In certain aspects, the vehicle dynamics model 438 models one or more of a vehicle behavior/operation, a vehicle attribute, a vehicle trajectory, and a vehicle position.

FIG. 5 illustrates the effect of object characteristics on the reflection of a LiDAR illumination beam, according to some aspects of the disclosed technology. With reference to FIGS. 1 and 2, a LiDAR sensor 120 emits an illumination beam 510 toward surface 212 of vehicle 210. The surface 212 has a perpendicular axis 520 and is oriented such that the angle 530 between the illumination beam 510 and the perpendicular 520 is small, e.g., 5 degrees. At the same time, an illumination beam 512 is emitted toward surface 214 that has a perpendicular axis 522. The surface 214 is oriented such that the angle 532 is large, e.g., 50 degrees.

Each surface 212, 214 will reflect the respective illumination beam 510, 512 and a portion of each reflected beam will be received by the LiDAR sensor 120. The intensities of the received portions, however, are different and dependent upon the respective characteristics of surfaces 212, 214.

FIG. 6 illustrates diffuse and specular reflection, according to some aspects of the disclosed technology. In this example, a light beam 610 is incident upon a flat surface 600 at an angle 612. A purely specular reflection will produce a specular reflection beam 620 at an angle 622 that is equal to angle 612. A diffuse reflection of beam 610 will produce a diffusion envelope 630 of reflected light beams 632. The magnitude of each beam 632 is a function of the angle of the beam 632 with respect to a perpendicular to the surface 600.

In general, reflection of the incident beam 610 will have a specular component and a diffuse component. The total energy of the reflected light will be less than the energy of the incident light, as a portion of the incident light will be absorbed by the surface 600. Highly polished surfaces will tend to have a larger portion of the incident light beam 610 reflected in a specular manner while rough surfaces will reflect a larger portion of the incident light beam 610 in a diffuse manner.

Without being bound by theory, a surface may be characterized by a diffuse-specular reflection parameter. In certain aspects, the diffuse-specular reflection parameter is provided as a normalized value on a defined scale, e.g., a scale of 0 (totally diffuse reflection, no specular reflection) to 40 (no diffuse reflection, all specular reflection). In certain aspects, the diffuse-specular reflection parameter comprises a description of the shape of diffusion envelope 630. In certain aspects, the diffuse-specular reflection parameter enables the calculation of the portion of the incident beam 610 that is reflected backward at angle 612 toward the LiDAR sensor.

Without being bound by theory, a surface may further be characterized by an absorption parameter. In certain aspects, the absorption parameter is provided as a normalized value on a defined scale, e.g., a scale of 0 (no absorption) to 4 (the incident light is not reflected).

Without being bound by theory, an environment of the LiDAR sensor, e.g., the ambient conditions of environment 40 surrounding LiDAR sensor 120, may be characterized by an environmental parameter. In certain aspects, the environmental parameter comprises a indication of visibility, e.g., attenuation of LiDAR light (illumination beam and its reflection) by rain. In certain aspects, the environmental parameter comprises an indication of ambient light, e.g., intensity of sunlight and/or street lights. In certain aspects, the environmental parameter comprises an indication of a reduction of the portion of the reflected light that is received by the LiDAR sensor due to a modification of the object, e.g., a dirty surface will reflect less light in general while a wet surface will reflect an increased percentage of incident light in a specular manner.

In certain aspects, determination of an intensity of the portion of the illumination beam that is received by a LiDAR sensor is dependent upon one or more of the diffuse-specular reflection parameters, the absorption parameter, and the environmental parameter. In certain aspects, one or more of the diffuse-specular reflection parameters, the absorption parameter, and the environmental parameter associated with a road data record are determined from a variable measured at the time that the range and intensity were measured, e.g., a light sensor configured to measure the intensity of the ambient light within the sensitive band of the LiDAR sensor. In certain aspects, one or more of the diffuse-specular reflection parameters, the absorption parameter, and the environmental parameter associated with a road data record are manually selected while preparing the data records.

In certain aspects, a neural network is trained with a set of training records as known to those of skill in the art. In certain aspects, each training record is a road data record, i.e., in contains measurements collected by a physical LiDAR sensor in the real world. In certain aspects, each measurement comprises a measured range and a measured intensity. In certain aspects, the road data record comprises a label assigned to the sensed object that reflected the illumination beam for the measurements of that record.

In certain aspects, the set of road data records used to train the neural network are augmented with additional information regarding the sensed object, e.g., the material of the object, the orientation of the object, or the diffuse-specular reflection parameter associated with a portion of the object. In certain aspects, the set of road data records used to train the neural network are augmented with environmental information, e.g., the environmental parameter associated with the environment in which the measurements were made.

aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other aspects of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. aspects may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In summary, the disclosed systems and methods provide systems and methods for determining a simulated intensity of a portion of the reflection of an illumination beam that is received by the LiDAR sensor. The simulated intensity is determined by a neural network trained with a set of road data records each comprising at least a measured range, a measured intensity, and an object label. In certain aspects, a diffuse-specular reflection parameter and/or an environmental parameter are provided and used to determine the intensity of the received LiDAR signal.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

In the above description, terms such as “upper,” “upward,” “lower,” “downward,” “above,” “below,” “longitudinal,” “lateral,” and the like, as used herein, are explanatory in relation to respective view of the item presented in the associated figure and are not limiting in the claimed use of the item. The term “outside” refers to a region that is beyond the outermost confines of a physical object. The term “inside” indicates that at least a portion of a region is partially contained within a boundary formed by the object.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language reciting “an item” or similar language indicates and includes one or more of the items. For example, claim language reciting “a part” means one part or multiple parts. Moreover, claim language reciting “at least one of” a set indicates that one member of the set or multiple members of the set satisfy the claim. For example, claim language reciting “at least one of A and B” means A, B, or A and B.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Aspects of the disclosure include:

Aspect 1: A method of simulating a Light Detection And Ranging (LiDAR) return signal, comprising: creating a model of an object and a LiDAR unit in a virtual environment, wherein: the LiDAR return signal comprises a return intensity of a reflection of an incident illumination beam by the object; and the model determines the LiDAR return signal based in part on a range from the LiDAR unit to the object and an object label; training the model with a set of road data records each comprising a measured range, a measured return intensity, and an object label; and simulating a LiDAR illumination beam emitted by the LiDAR unit toward the object and determining the return intensity of the reflection of an incident portion of the emitted illumination beam.

Aspect 2: The method of Aspect 1, wherein: the object model comprises a surface that is made of a material and has an orientation relative to the LiDAR sensor; the object label is associated with the material; a portion of the illumination beam is reflected by the surface; and the determination of the return intensity is based in part on at least one of the material and the orientation of the surface.

Aspect 3: The method of any of Aspects 1-2, wherein: the object model further comprises a finish of the surface; and the determination of the return intensity is based in part on the finish.

Aspect 4: The method of Aspects 1-3, wherein: the object model further comprises a diffuse-specular reflection parameter; and the determination of the return intensity is based in part on the diffuse-specular reflection parameter.

Aspect 5: The method of any of Aspects 1-4, wherein: the road data records each comprise an identification of one or more of: an environmental parameter associated with the environment of the LiDAR sensor at the time that the range and intensity were measured; a material of the observed object; a finish of the observed object; and a diffuse-specular reflection parameter associated with the observed object.

Aspect 6: The method of Aspects 1-5, wherein: the object label is associated with the finish; and the environmental parameter is associated with the diffuse-specular reflection parameter.

Aspect 7: The method of Aspects 1-6, wherein: one or more of the material, the finish, the diffuse-specular reflection parameter, and the environmental parameter are manually selected.

Aspect 8: A non-transitory computer-readable memory comprising instructions for simulating a Light Detection And Ranging (LiDAR) return signal that, when loaded into a processor and executed, cause the process to execute the steps of: creating a model of an object and a LiDAR unit in a virtual environment, wherein: the LiDAR return signal comprises a return intensity of a reflection of an incident illumination beam by the object; and the model determines the LiDAR return signal based in part on a range from the LiDAR unit to the object and an object label; training the model with a set of road data records each comprising a measured range, a measured return intensity, and an object label; and simulating a LiDAR illumination beam emitted by the LiDAR unit toward the object and determining the return intensity of the reflection of an incident portion of the emitted illumination beam.

Aspect 9: The memory of Aspect 8, wherein: the object model comprises a surface that is made of a material and has an orientation relative to the LiDAR sensor; the object label is associated with the material; a portion of the illumination beam is reflected by the surface; and the determination of the return intensity is based in part on at least one of the material and the orientation of the surface.

Aspect 10: The memory of Aspects 8-9, wherein: the object model further comprises a finish of the surface; and the determination of the return intensity is based in part on the finish.

Aspect 11: The memory of Aspects 8-10, wherein: the object model further comprises a diffuse-specular reflection parameter; and the determination of the return intensity is based in part on the diffuse-specular reflection parameter.

Aspect 12: The memory of Aspects 8-11, wherein: the road data records each comprise an identification of one or more of: an environmental parameter associated with the environment of the LiDAR sensor at the time that the range and intensity were measured; a material of the observed object; a finish of the observed object; and a diffuse-specular reflection parameter associated with the observed object.

Aspect 13: The memory of Aspects 8-12, wherein: the object label is associated with the finish; and the environmental parameter is associated with the diffuse-specular reflection parameter.

Aspect 14: The memory of Aspects 8-13, wherein: one or more of the material, the finish, the diffuse-specular reflection parameter, and the environmental parameter are manually selected.

Aspect 15: A system for simulating a Light Detection And Ranging (LiDAR) return signal, comprising: a processor; and a non-transitory computer-readable memory coupled to the processor and comprising instructions for operating a seismic sensing system that, when loaded into a processor and executed, cause the process to execute the steps of: creating a model of an object and a LiDAR unit in a virtual environment, wherein: the LiDAR return signal comprises a return intensity of a reflection of an incident illumination beam by the object; and the model determines the LiDAR return signal based in part on a range from the LiDAR unit to the object and an object label; training the model with a set of road data records each comprising a measured range, a measured return intensity, and an object label; and simulating a LiDAR illumination beam emitted by the LiDAR unit toward the object and determining the return intensity of the reflection of an incident portion of the emitted illumination beam.

Aspect 16: The system of Aspect 15, wherein: the object model comprises a surface that is made of a material and has an orientation relative to the LiDAR sensor; the object label is associated with the material; a portion of the illumination beam is reflected by the surface; and the determination of the return intensity is based in part on at least one of the material and the orientation of the surface.

Aspect 17: The system of Aspects 15-16, wherein: the object model further comprises a finish of the surface; and the determination of the return intensity is based in part on the finish.

Aspect 18: The system of Aspects 15-17, wherein: the object model further comprises a diffuse-specular reflection parameter; and the determination of the return intensity is based in part on the diffuse-specular reflection parameter.

Aspect 19: The system of Aspects 15-18, wherein: the road data records each comprise an identification of one or more of: an environmental parameter associated with the environment of the LiDAR sensor at the time that the range and intensity were measured; a material of the observed object; a finish of the observed object; and a diffuse-specular reflection parameter associated with the observed object.

Aspect 20. The system of Aspects 15-19, wherein: the object label is associated with the finish; and the environmental parameter is associated with the diffuse-specular reflection parameter.

What is claimed is:

1. A method of simulating a Light Detection And Ranging (LiDAR) return signal, comprising:
creating a model of an object and a LiDAR unit in a virtual environment, wherein:
the LiDAR return signal comprises a return intensity of a reflection of an incident illumination beam by the object; and
the model determines the LiDAR return signal based in part on a range from the LiDAR unit to the object and an object label;
training the model with a set of road data records each comprising a measured range, a measured return intensity, and an object label; and
simulating a LiDAR illumination beam emitted by the LiDAR unit toward the object and determining the return intensity of the reflection of an incident portion of the emitted illumination beam.

2. The method of claim 1, wherein:
the object model comprises a surface that is made of a material and has an orientation relative to the LiDAR unit;
the object label is associated with the material;
a portion of the illumination beam is reflected by the surface; and
the determination of the return intensity is based in part on at least one of the material and the orientation of the surface.

3. The method of claim 2, wherein:
the object model further comprises a finish of the surface; and
the determination of the return intensity is based in part on the finish.

4. The method of claim 3, wherein:
the object model further comprises a diffuse-specular reflection parameter; and
the determination of the return intensity is based in part on the diffuse-specular reflection parameter.

5. The method of claim 2, wherein:
the road data records each comprise an identification of one or more of:
an environmental parameter associated with the environment of the LiDAR sensor at a time that the range and intensity were measured;
a material of an observed object;
a finish of the observed object; and
a diffuse-specular reflection parameter associated with the observed object.

6. The method of claim 5, wherein:
the object label is associated with the finish; and
the environmental parameter is associated with the diffuse-specular reflection parameter.

7. The method of claim 6, wherein:
one or more of the material, the finish, the diffuse-specular reflection parameter, and the environmental parameter are manually selected.

8. A non-transitory computer-readable memory comprising instructions for simulating a Light Detection And Ranging (LiDAR) return signal that, when loaded into a processor and executed, cause the processor to execute steps for:
creating a model of an object and a LiDAR unit in a virtual environment, wherein:
the LiDAR return signal comprises a return intensity of a reflection of an incident illumination beam by the object; and
the model determines the LiDAR return signal based in part on a range from the LiDAR unit to the object and an object label;
training the model with a set of road data records each comprising a measured range, a measured return intensity, and an object label; and
simulating a LiDAR illumination beam emitted by the LiDAR unit toward the object and determining the return intensity of the reflection of an incident portion of the emitted illumination beam.

9. The memory of claim 8, wherein:
the object model comprises a surface that is made of a material and has an orientation relative to the LiDAR unit;
the object label is associated with the material;
a portion of the illumination beam is reflected by the surface; and
the determination of the return intensity is based in part on at least one of the material and the orientation of the surface.

10. The memory of claim 9, wherein:
the object model further comprises a finish of the surface; and
the determination of the return intensity is based in part on the finish.

11. The memory of claim 10, wherein:
the object model further comprises a diffuse-specular reflection parameter; and
the determination of the return intensity is based in part on the diffuse-specular reflection parameter.

12. The memory of claim 9, wherein:
the road data records each comprise an identification of one or more of:
an environmental parameter associated with the environment of the LiDAR sensor at a time that the range and intensity were measured;
a material of an observed object;
a finish of the observed object; and
a diffuse-specular reflection parameter associated with the observed object.

13. The memory of claim 12, wherein:
the object label is associated with the finish; and
the environmental parameter is associated with the diffuse-specular reflection parameter.

14. The memory of claim 13, wherein:
one or more of the material, the finish, the diffuse-specular reflection parameter, and the environmental parameter are manually selected.

15. A system for simulating a Light Detection And Ranging (LiDAR) return signal, comprising:
a processor; and
a non-transitory computer-readable memory coupled to the processor and comprising instructions for operating a seismic sensing system that, when loaded into a processor and executed, causes the processer to execute steps for:
creating a model of an object and a LiDAR unit in a virtual environment, wherein:
the LiDAR return signal comprises a return intensity of a reflection of an incident illumination beam by the object; and
the model determines the LiDAR return signal based in part on a range from the LiDAR unit to the object and an object label;
training the model with a set of road data records each comprising a measured range, a measured return intensity, and an object label; and
simulating a LiDAR illumination beam emitted by the LiDAR unit toward the object and determining the return intensity of the reflection of an incident portion of the emitted illumination beam.

16. The system of claim 15, wherein:
the object model comprises a surface that is made of a material and has an orientation relative to the LiDAR unit;
the object label is associated with the material;
a portion of the illumination beam is reflected by the surface; and
the determination of the return intensity is based in part on at least one of the material and the orientation of the surface.

17. The system of claim 16, wherein:
the object model further comprises a finish of the surface; and
the determination of the return intensity is based in part on the finish.

18. The system of claim 17, wherein:
the object model further comprises a diffuse-specular reflection parameter; and
the determination of the return intensity is based in part on the diffuse-specular reflection parameter.

19. The system of claim 16, wherein:
the road data records each comprise an identification of one or more of:
an environmental parameter associated with the environment of the LiDAR sensor at a time that the range and intensity were measured;
a material of an observed object;
a finish of the observed object; and
a diffuse-specular reflection parameter associated with the observed object.

20. The system of claim 19, wherein:
the object label is associated with the finish; and
the environmental parameter is associated with the diffuse-specular reflection parameter.
